(19) United States
(12) Patent Application Publication
(10) Pub. No.: US 2016/0307485 A1
(43) Pub. Date: Oct. 20, 2016

(54) IMAGE SELF-CALIBRATION METHOD AND DEVICE FOR LCD DISPLAYS

(71) Applicants: Chih-Hung MA, New Taipei City (TW); Tsung-Lung YANG, New Taipei City (TW); Chih-Wei KUO, New Taipei City (TW); Shih-Pang WANG, New Taipei City (TW); Meng-Han TSAI, New Taipei City (TW)

(72) Inventors: Chih-Hung MA, New Taipei City (TW); Tsung-Lung YANG, New Taipei City (TW); Chih-Wei KUO, New Taipei City (TW); Shih-Pang WANG, New Taipei City (TW); Meng-Han TSAI, New Taipei City (TW)

(21) Appl. No.: 14/688,097

(22) Filed: Apr. 16, 2015

(51) Int. Cl. G09G 3/00; G09G 3/20; G09G 3/34

(52) U.S. Cl. CPC G09G 3/006; G09G 3/3413; G09G 3/2003; G09G 2320/0693; G09G 2360/145

(57) ABSTRACT

The present invention provides an image self-calibration method and device for LCD displays, comprising a front optical sensor and a calibration reference device. The front optical sensor is employed to calibrate the gray scale level and color temperature of the display. The calibration reference device is employed to pre-calibrate the front optical sensor. The present invention has the following advantages. Image pre-calibration is performed on the installed optical sensor before it leaves a factory, and the calibrated optical sensor directly performs gray scale level and color temperature calibration on the display. The present invention is easy to implement, can effectively inspect and calibrate images on the display, and can save human resources and reduce manufacture and maintenance time.

### BACKGROUND OF THE INVENTION

1. Field of the Invention

The present invention relates to an image self-calibration method and device for LCD displays that saves human resources and reduces manufacture and maintenance time.

2. Description of Related Art

Current technology applied in image calibration for displays may be classified into two types: hardware calibration and software calibration. Hardware calibration stores calibrated data in a storage device inside a display, while software calibration performs image calibration using a computer with built-in ICC profile.

Both hardware calibration and software calibration for conventional displays require equipment such as computer and colorimeter as well as professional software for display calibration. On some occasions it is not convenient to set up these external devices, for example for a wall display already embedded or a display in an operation room. In particular, for medical equipment that are intensively used and that require high-standard images, maintenance cost of external devices and professional software is high.

However, each display panel is slightly different when manufactured. They have slightly different physical properties and maximum luminance. Gamma correction and color temperature compensation further increase differences in their luminance. Especially the display for medical diagnosis that require precise image presentation in gray scale level, Gamma value, luminance, and chromaticness. This invention is to ensure display system working properly, and to make sure physicians read medical images in good quality while performing medical diagnosis and report.

The prior art disclosed in Taiwan patent publication No. 200627369 only provides a method for calibrating image color temperature, wherein images are recorded via physical characteristics of electronic circuits.

### SUMMARY OF THE INVENTION

To solve the foregoing problems, the present invention employs an optical sensor accompanied by sensing elements disposed on a display. The optical sensor is calibrated before leaving a factory so that image self-calibration may be performed by the display itself without need of any external device and software. The present invention may be applied on occasions when it is not convenient to set up external devices and may reduce corrective maintenance cost of displays.

The primary purpose of the present invention is to provide an image self-calibration method for LCD displays which employs a front optical sensor disposed on the display to calibrate the gray scale level and color temperature of the display. The optical sensor will be pre-calibrated before use to maintain stable and consistent reference values.

Further, the foregoing method specifically includes the following steps: (1) set up a front optical sensor on a display; (2) calibrate the front optical sensor with a calibration reference device; (3) the front optical sensor calibrates the gamma value and color temperature of the display.

The present invention further provides an image self-calibration device for LCD displays comprising a front optical sensor disposed in front of an LCD display panel and a calibration reference device disposed in a middle of the LCD display. The calibration reference device and the display are connected to a computer. The front optical sensor is employed to calibrate the gray scale level and color temperature of the display. The calibration reference device is employed to pre-calibrate the front optical sensor.

The present invention has the following advantages. Image pre-calibration is performed on the installed optical sensor before it leaves a factory, and the calibrated optical sensor directly performs gray scale level and color temperature calibration on the display. The present invention is easy to implement and can effectively inspect and calibrate images on displays.

### BRIEF DESCRIPTION OF THE DRAWINGS

FIG. 1 is a schematic view of image calibration performed on a front optical sensor according to the present invention; and

FIG. 2 is a schematic view of image self-calibration performed by the front optical sensor itself according to the present invention.

### DETAILED DESCRIPTION OF THE PREFERRED EMBODIMENTS

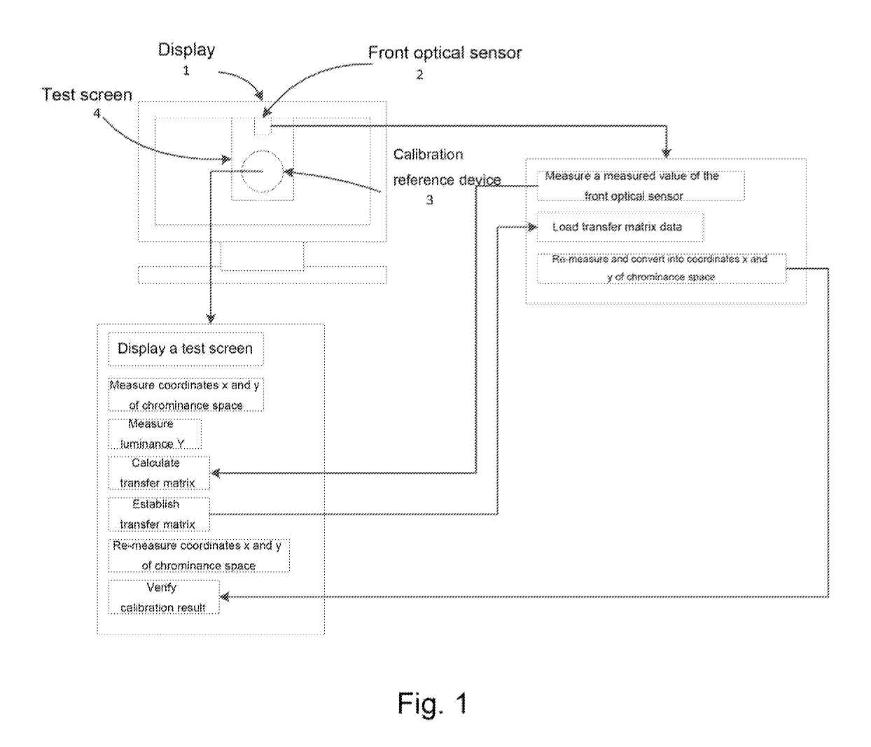

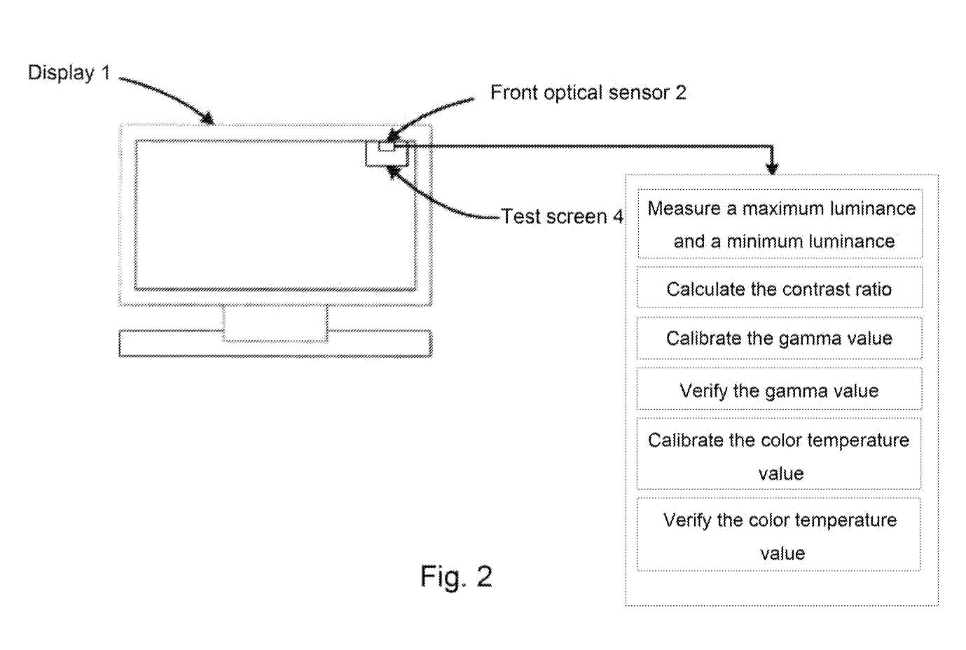

The foregoing purposes of the present invention along with its structure and performance characteristics are further illustrated in the following description of specific embodiments in conjunction with the accompanying figures. Please refer to FIGS. 1 and 2.

The present invention is illustrated in a flow diagram and a schematic flow diagram including the following three steps.

Step 1: set up a front optical sensor on a display. A front optical sensor 2 is disposed in front of an LCD display 1 panel to prevent LCD display panel degradation from causing luminance attenuation, so that measurement data may be more accurate.

Step 2: calibrate the front optical sensor, perform the following steps to get measurement data, and compare the measurement data with those obtained by the calibration reference device 3. When the difference between the measurement data and the calibration reference device 3 is smaller than the margin of error, Delta E (2000)<5, the calibration is successful.

A. Set up a colorimeter or a spectrometer in an appropriate position on the display to serve as a calibration reference device 3;

B. Connect the display 1 and the calibration reference device 3 to a computer;

C. Calibrate the luminance of the display 1 to a minimum value within a range of application and display a completely black test screen. After the luminance becomes stable, the

optical sensor 2 measures Red, Green, and Blue channels and the obtained data is

$$[ \begin{matrix}{R}_{0} \\ {G}_{0} \\ {B}_{0}\end{matrix} ] ,$$

while the calibration reference device 3 measures the coordinates x and y of chrominance space and luminance (brightness) Y and the obtained data is

$$[ \begin{matrix}{x}_{0} \\ {y}_{0} \\ {Y}_{0}\end{matrix} ] ;$$

D. Display a test screen 4 on the display 1. The calibration reference device 3 measures the coordinates x and y of chrominance space and luminance (brightness) Y and stores the measured data. Simultaneously the front optical sensor measures the Red, Green, and Blue channels and the clear channel and stores the measured data:
Test screen in application: rgb=(255 0 0), rgb=(0 255 0), rgb=(0 0 255)
Three sets of measured data of three test screens obtained by the calibration reference device

$$[ \begin{matrix}{x}_{R} \\ {y}_{R} \\ {Y}_{R}\end{matrix} ] , [ \begin{matrix}{x}_{G} \\ {y}_{G} \\ {Y}_{G}\end{matrix} ] , [ \begin{matrix}{x}_{B} \\ {y}_{B} \\ {Y}_{B}\end{matrix} ] \qquad 3$$

$$[ \begin{matrix}{R}_{R} \\ {G}_{R} \\ {B}_{R}\end{matrix} ] , [ \begin{matrix}{R}_{G} \\ {G}_{G} \\ {B}_{G}\end{matrix} ] , [ \begin{matrix}{R}_{B} \\ {G}_{B} \\ {B}_{B}\end{matrix} ] ;$$

Measured data obtained by the corresponding front optical sensor:

E. Apply the relation equation of chrominance space and color stimulus, wherein the x and y in the equation are coordinates of chrominance space and the X. Y, and Z are color stimulus:

$$\{ \begin{matrix}x = \frac{X}{( X + Y + Z )} \\ y = \frac{Y}{( X + Y + Z )}\end{matrix} \} \\ \{ \begin{matrix}X = \frac{x}{y} Y \\ Y = Y \\ Z = \frac{1 - x - y}{y} Y\end{matrix} \} \qquad Equation 1$$

Transfer the measured data obtained in steps 3 and 4 by the calibration reference device 3 into color stimulus and get four sets of color stimulus:

$$[ \begin{matrix}{X}_{0} \\ {Y}_{0} \\ {Z}_{0}\end{matrix} , ] [ \begin{matrix}{X}_{R} \\ {Y}_{R} \\ {Z}_{R}\end{matrix} , ] [ \begin{matrix}{X}_{G} \\ {Y}_{G} \\ {Z}_{G}\end{matrix} , ] [ \begin{matrix}{X}_{B} \\ {Y}_{B} \\ {Z}_{B}\end{matrix} ] ;$$

F. Establish a transfer matrix between the measured data obtained by the front optical sensor and the color stimulus obtained in step 4. Get a transfer matrix coefficient and establish a conversion equation:

$$[ \begin{matrix}{X}_{ref} \\ {Y}_{ref} \\ {Z}_{ref}\end{matrix} ] = {M}_{3 \times 3} \times [ \begin{matrix}{R}_{mes} - {R}_{0} \\ {G}_{mes} - {G}_{0} \\ {B}_{mes} - {B}_{0}\end{matrix} ] + [ \begin{matrix}{X}_{0} \\ {Y}_{0} \\ {Z}_{0}\end{matrix} ] , \qquad Equation 2$$

wherein

$$[ \begin{matrix}{X}_{ref} \\ {Y}_{ref} \\ {Z}_{ref}\end{matrix} ]$$

is the color stimulus, and

$$[ \begin{matrix}{R}_{mes} \\ {G}_{mes} \\ {B}_{mes}\end{matrix} ]$$

is the measured data obtained by the front optical sensor;
Enter into the conversion equation the measured data obtained by the front optical sensor and the color stimulus measured and converted by the calibration reference device 3 at steps 3, 4, and 5 and get the transfer matrix M.

$$[ \begin{matrix}{X}_{R} \\ {Y}_{R} \\ {Z}_{R}\end{matrix} ] = {M}_{3 \times 3} \times [ \begin{matrix}{R}_{R} - {R}_{0} \\ {G}_{R} - {G}_{0} \\ {B}_{R} - {B}_{0}\end{matrix} ] + [ \begin{matrix}{X}_{0} \\ {Y}_{0} \\ {Z}_{0}\end{matrix} ] \\ [ \begin{matrix}{X}_{G} \\ {Y}_{G} \\ {Z}_{G}\end{matrix} ] = {M}_{3 \times 3} \times [ \begin{matrix}{R}_{G} - {R}_{0} \\ {G}_{G} - {G}_{0} \\ {B}_{G} - {B}_{0}\end{matrix} ] + [ \begin{matrix}{X}_{0} \\ {Y}_{0} \\ {Z}_{0}\end{matrix} ] \\ [ \begin{matrix}{X}_{B} \\ {Y}_{B} \\ {Z}_{B}\end{matrix} ] = {M}_{3 \times 3} \times [ \begin{matrix}{R}_{B} - {R}_{0} \\ {G}_{B} - {G}_{0} \\ {B}_{B} - {B}_{0}\end{matrix} ] + [ \begin{matrix}{X}_{0} \\ {Y}_{0} \\ {Z}_{0}\end{matrix} ] ; \qquad Equation 3$$

G. Display other test screens on the display and measure them by the front optical sensor to obtain measured data. Convert the measured data into x, y, and Y via equations 4, 2, and 1. Compare x, y, and Y with the measured data obtained by the calibration reference device 3. When the difference between them is smaller than the margin of error, the calibration is successful.

Step 3: the front optical sensor calibrates the display.

A. Measure a minimum luminance value Lₘᵢₙ and a maximum luminance value Lₘₐₓ of the display by the front optical sensor. Calculate the contrast radio C=Lₘₐₓ/Lₘᵢₙ of the display to confirm that it corresponds to the specifications of DICOM;

B. Calibrate the gamma value by performing the following steps:
a. Control and calibrate a backlight of the display to an appropriate luminance with feedback from the front optical sensor. The luminance must be greater than a minimum luminance as specified in DICOM;
b. Show a 32-level gray scale test screen on the display, which is measured and recorded by the front optical sensor to serve as a reference luminance. Also, establish a luminance characteristic curve:
c. Based on the requirements of display chip, interpolate the reference luminance by performing three cubic spline interpolations and get the luminance reference table required by the display chip. The size of the luminance reference table is n;
d. Use the target gamma value and gamma value equation 5 to calculate the luminance value required for each level. Select a nearest corresponding level from the luminance reference table and enter it into the gamma table.

L(x)=L₀+(Lₙ₋₁−L₀)×(x/n)^{y} x=0,1 . . . n−1; and Equation 5
e. Firmware of the display loads the gamma table obtained in step 4 and measures the gray scale curve again to verify whether the result of the calibration is correct and complete gamma calibration.

C: Calibrate the color temperature by performing the following steps:
a. Control and calibrate a backlight of the display to an appropriate luminance with feedback from the front optical sensor. The luminance must be greater than a minimum luminance as specified in DICOM;
b. Show a completely white test screen on the display. The front optical sensor uses the transfer matrix to measure the coordinates x and y of the current chrominance space and luminance (brightness) Y of the display, and Red, Green, Blue gain values of the display in the temporary storage. R-Gain is directly proportional to the x in color coordinates (x, y) which corresponds to the color temperature, G-Gain is directly proportional to y, and B-Gain is inversely proportional to x and y. Further, R-Gain. G-Gain, B-Gain and the luminance Y satisfy the following equation: Y=0.299*R Gain+0.587*G Gain+0.114*B Gain. Hence, calibrate the R-Gain, G-Gain, and B-Gain of the display in the temporary storage to calibrate the color temperature of the display screen;
c. Firmware of the display loads the R-Gain, G-Gain, and B-Gain values and measures the coordinates x and y of the chrominance space and luminance (brightness) Y of the display again to verify whether they fall within a margin of tolerable error and complete color temperature calibration.

The present invention performs image pre-calibration on an installed front optical sensor and uses the front optical sensor to directly calibrate the gray scale level and color temperature of the display. The present invention is easy to implement and can effectively inspect and calibrate images on the display.

The foregoing preferred embodiments of the present invention are illustrated of the present invention rather than limiting of the present invention. It is intended to cover various modifications and changes included within the spirit and scope of the appended claims, the scope of which should be accorded the broadest interpretation so as to encompass all such modifications and similar structures.

What is claimed is:

1. A method of image self-calibration for LCD displays, wherein calibration is performed by a front optical sensor on the display to calibrate the gray scale level and color temperature of the display; and wherein the front optical sensor requires pre-calibration before use.

2. The method of image self-calibration for LCD displays as defined in claim 1, wherein the method specifically includes the following steps:
(1) Set up a front optical sensor on a display;
(2) Calibrate the front optical sensor with a calibration reference device; and
(3) The front optical sensor calibrates the gamma value and color temperature of the display.

3. The method of image self-calibration for LCD displays as defined in claim 2, wherein step 2 further includes the following steps:
(21) Set up a calibration reference device in front of the display;
(22) Connect the display and the calibration reference device to a computer;
(23) Display a test screen on the display. The calibration reference device measures the coordinates x and y of chrominance space and luminance Y and stores the measured data on the computer. The front optical sensor measures the display and stores the measured data;
(24) Enter the measured data obtained by the calibration reference device in step (23) into a relation equation of the chrominance space and color stimulus to get color stimulus;
(25) Establish a transfer matrix between the measured data obtained by the front optical sensor in step (23) and the color stimulus obtained in step (24) to get a transfer matrix coefficient;
(26) Display other test screens on the display and measure them by the front optical sensor to obtain measured data. Convert the measured data into coordinates of chrominance space and luminance. Compare them with the measured data obtained by the calibration reference device. When the difference between them is smaller than the margin of error, Delta E (2000)<5, the calibration is successful.

4. The method of image self-calibration for LCD displays as defined in claim 2, wherein the calibration reference device is a colorimeter or a spectrometer.

5. The method of image self-calibration for LCD displays as defined in claim 2, wherein gamma value calibration performed by the front optical sensor includes the following steps:
(311) Control and calibrate a backlight of the display with feedback from the front optical sensor, so that its luminance is greater than a minimum luminance as specified in DICOM;
(312) Show a test screen on the display, which is measured and recorded by the front optical sensor to serve as a reference luminance. Also, establish a luminance characteristic curve based on the reference luminance;
(313) Based on the requirements of display chip, interpolate the reference luminance and get the luminance reference table required by the display chip. The size of the luminance reference table is n;
(314) Use the target gamma value and gamma value equation. L(x)=L₀+(Lₙ₋₁−L₀)×(x/n)^{y}, to calculate the luminance value required for each level. Select a nearest corresponding level from the luminance reference table and enter it into the gamma table; and
(315) Firmware of the display loads the gamma table obtained in step (314) and measures the gray scale curve again to verify whether the result of the calibration is correct and complete gamma calibration.

6. The method of image self-calibration for LCD displays as defined in claim 5, wherein the following steps are further included before step (311):
Measure a minimum luminance value Lₘᵢₙ and a maximum luminance value Lₘₐₓ of the display by the front optical sensor. Calculate the contrast radio C=Lₘₐₓ/Lₘᵢₙ of the display to confirm that it corresponds to the specifications of DICOM.

7. The method of image self-calibration for LCD displays as defined in claim 5, wherein in step (313) the reference luminance is interpolated by three cubic spline interpolations.

8. The method of image self-calibration for LCD displays as defined in claim 2, wherein color temperature calibration performed by the front optical sensor includes the following steps:
(321) Control and calibrate a backlight of the display with feedback from the front optical sensor, so that the luminance is greater than a minimum luminance as specified in DICOM;
(322) Show a test screen on the display. The front optical sensor obtains measured data and uses a transfer matrix to measure the coordinates of the current chrominance space and luminance (brightness) of the display. Calibrate the R-Gain, G-Gain, and B-Gain of the display in the temporary storage to calibrate the color temperature of the display screen based on a relation between the R-Gain, G-Gain, and B-Gain and coordinates of chrominance space;
(323) Firmware of the display loads the calibrated R-Gain. G-Gain, and B-Gain values and measures the coordinates of the chrominance space and luminance of the display again to verify whether they fall within a margin of tolerable error, Delta E (2000)<5, and complete color temperature calibration.

9. An image self-calibration device for LCD displays, comprising a front optical sensor disposed in front of an LCD display panel and a calibration reference device disposed in a middle of the LCD display. The calibration reference device and the display are connected to a computer. The front optical sensor is employed to calibrate the gray scale level and color temperature of the display. The calibration reference device is employed to pre-calibrate the front optical sensor.

10. The image self-calibration device for LCD displays as defined in claim 9, wherein the calibration reference device is a colorimeter or a spectrometer.
